(19) United States
(12) Patent Application Publication
(10) Pub. No.: US 2014/0150007 A1
(43) Pub. Date: May 29, 2014

(54) AUTOMATED POINT-BASED ENTERTAINMENT BETTING

(71) Applicant: CBS INTERACTIVE INC., San Francisco, CA (US)

(72) Inventors: Jason Randall, Oakland, CA (US); Steven Leung, San Francisco, CA (US)

(73) Assignee: CBS INTERACTIVE INC., San Francisco, CA (US)

(21) Appl. No.: 13/686,505

(22) Filed: Nov. 27, 2012

(51) Int. Cl. H04N 21/4784

(52) U.S. Cl. CPC H04N 21/4784
USPC 725/23

(57) ABSTRACT

Various embodiments are generally directed to automated provision of online interactive activities to members of the audience of an audio/visual program (e.g., a program comprising audio and/or video). An apparatus comprises a processor circuit and a storage communicatively coupled to the processor circuit and arranged to store instructions operative on the processor circuit to receive a signal from a presentation server that indicates a selected possibility of multiple possibilities of an aspect of an episode of an audio/visual program; determine whether a bet placed on one possibility of the multiple possibilities was placed on the selected possibility; and update an individual account associated with the bet to add a quantity of points won to a quantity of accrued points of the individual account if the one possibility on which the bet was placed matches the selected possibility. Other embodiments are described and claimed herein.

### BACKGROUND

Audio/visual programs for entertainment (e.g., weekly entertainment television shows, recurring mini-series, recurring movie-length entertainment specials, seasonal sports events, etc.) are typically presented to audience members in sets of episodes over a period often referred to as “seasons” that each extend through portions of calendar years, and are separated by intervals of time in which they are not presented, or in which previously presented episodes are presented again. In the case of scripted entertainment programs, such periodic presentations of sets of episodes are necessitated by the amount of time required to create each episode such that not enough episodes are able to be created quickly enough to enable presentation of new episodes throughout a year. In the case of seasonal sports events, such periodic presentations of sets of episodes are necessitated simply by the fact of those sports events being played only through part of each year, and not being played throughout the entirety of a year.

During the intervals of time between such seasons in which at least new episodes of a program are not being presented to audience members, those audience members may lose interest in those programs and may be less inclined to again devote time to watching and/or listening to those programs once a new season begins in which new episodes are again presented. Over multiple such intervals between seasons audience interest may decline to an extent that the continued creation and presentation of new episodes becomes unsustainable.

A need exists to in some way maintain audience interest in these programs in those intervals between seasons. It is with respect to these and other considerations that the techniques described herein are needed.

### BRIEF DESCRIPTION OF THE DRAWINGS

FIG. 1 illustrates a first embodiment of interaction among computing devices.

FIG. 2 illustrates a portion of the embodiment of FIG. 1.

FIG. 3 illustrates a portion of the embodiment of FIG. 1.

FIG. 4 illustrates a portion of the embodiment of FIG. 1.

FIG. 5 illustrates a portion of the embodiment of FIG. 1.

FIG. 6 illustrates an embodiment of a first logic flow.

FIG. 7 illustrates an embodiment of a second logic flow.

FIG. 8 illustrates an embodiment of a third logic flow.

FIG. 9 illustrates an embodiment of a fourth logic flow.

FIG. 10 illustrates an embodiment of a fifth logic flow.

FIG. 11 illustrates an embodiment of a sixth logic flow.

FIG. 12 illustrates an embodiment of a processing architecture.

### DETAILED DESCRIPTION

Various embodiments are generally directed to automated provision of online interactive activities to members of the audience of an audio/visual program (e.g., a program comprising audio and/or video). Some embodiments are particularly directed to automated provision of opportunities for audience members to earn points through participation in those online activities, and to employ those points in placing bets on possible outcomes of events or other aspects of upcoming episodes of that program.

More specifically, automated provision is made for members of a program's audience to build up a personal reputation as being knowledgeable and engaged in that program, as measured by a quantity of points that each such audience member accrues through participation in various automated online activities related to that program. Such automated activities may include, without limitation, viewing presentations of videos and/or other content related to that program (e.g., outtakes of recordings of scenes, so-called “blooper reels,” biographies and/or interviews of persons related to that program, etc.), participating in online discussion forums with other audience members about aspects of that program, participating in automated online quizzes and/or various online games related to that program, etc.

Upon earning sufficient points, audience members may be automatically presented with opportunities to use at least some of those points in acquiring products related to that program, and/or automatically presented with opportunities to use at least some of those points in placing bets on aspects of upcoming episodes of that program, including possible outcomes of events occurring in those episodes. Such aspects may include, without limitation, actions that a fictional character in that program may take, identifying a fictional character that may leave the storyline of that program and/or how they may leave, identifying participants in that program that may be removed as a result of the progress of game play in that program, etc. By way of example, upon presentation of a final episode of a current season of a scripted audio/visual program, audience members may be automatically presented with an opportunity to bet on which fictional character may be revealed in the first episode of the next season to have “died” in that final episode of the current season. By way of another example, upon presentation of an episode of a “reality” program, audience members may be automatically presented with an opportunity to bet on which participant in that program will be “voted off the island” or which participant will win or lose a “round” of a series of challenges of skill and/or sportsmanship in that program.

As will be explained in greater detail, interested audience members are provided with accounts maintained on a participation server by which point counts and various records of participation by individual audience members in interactive online activities related to a program are maintained. Also maintained via such accounts may be indicators of the identity of one or more computing devices by which those interested audience members often view episodes of that program and/or participate in those interactive activities, thereby enabling further automated contacting of those audience members with information related to that program and/or opportunities to further participate in interactive activities related to that program, including betting.

In one embodiment, for example, an apparatus comprises a processor circuit and a storage communicatively coupled to the processor circuit and arranged to store instructions. The instructions are operative on the processor circuit to receive a signal from a presentation server that indicates a selected possibility of multiple possibilities of an aspect of an episode of an audio/visual program; determine whether a bet placed on one possibility of the multiple possibilities was placed on the selected possibility; and update an individual account associated with the bet to add a quantity of points won to a quantity of accrued points of the individual account if the one possibility on which the bet was placed matches the selected possibility.

With general reference to notations and nomenclature used herein, portions of the detailed description which follows may be presented in terms of program procedures executed on a computer or network of computers. These procedural descriptions and representations are used by those skilled in the art to most effectively convey the substance of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may comprise a general purpose computer. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

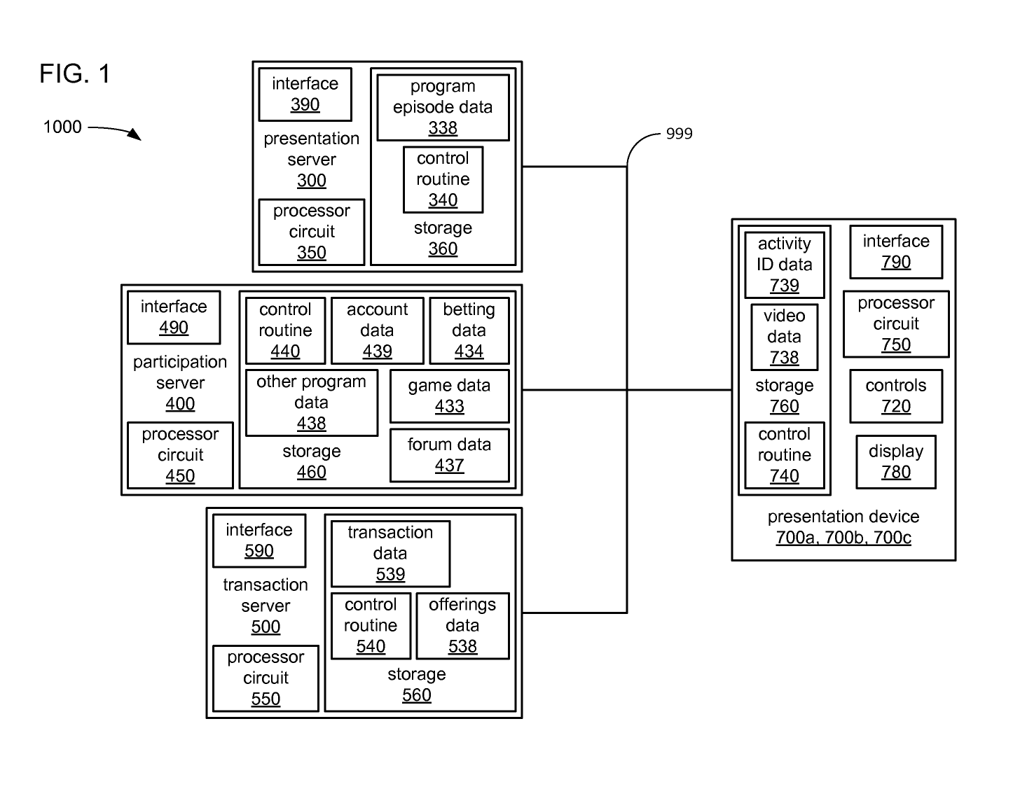

FIG. 1 illustrates a block diagram of a audio/visual program participation system 1000 comprising one or more of a presentation server 300, a participation server 400, a transaction server 500, and one or more of presentation devices 700a-c. Each of these computing devices 300, 400, 500 and 700a-c may be any of a variety of types of computing device, including without limitation, a desktop computer system, a data entry terminal, a laptop computer, a netbook computer, a tablet computer, an ultrabook computer, a handheld personal data assistant, a smartphone, a body-worn computing device incorporated into clothing, a computing device integrated into a vehicle (e.g., a car, a bicycle, a wheelchair, etc.), a server, a cluster of servers, a server farm, etc. As depicted, these computing devices 300, 400, 500 and 700a-c exchange signals concerning an audio/visual program and interactive online participation related to that program through portions of at least one network 999. In various embodiments, the network 999 may be a single network possibly limited to extending within a single building or other relatively limited area, a combination of connected networks possibly extending a considerable distance, and/or may include the Internet. Thus, the network 999 may be based on any of a variety (or combination) of communications technologies by which signals may be exchanged, including without limitation, wired technologies employing electrically and/or optically conductive cabling, and wireless technologies employing infrared, radio frequency or other forms of wireless transmission.

As depicted, the presentation server 300 transmits episodes of an audio/visual program to one or more of the presentation devices 700a-c for audio and/or visual presentation by those presentation devices to one or more members of an audience. As the presentation server 300 does so, it may transmit an indication to the participation server 400 of the fact of the presentation of one of various possibilities of an aspect of an episode of that program (e.g., one of various possible outcomes of an event occurring in that episode) on which audience members may have used accrued points to place bets (also commonly referred to as wagers, stakes, etc.). At an earlier time, the participation server 400, in cooperation with one or more of the presentation devices 700a-c, presented one or more audience members with an opportunity to use some of their accrued points to place a bet on which one of those various possibilities (e.g., outcomes) would occur in that episode of that program before and/or while it is presented. The participation server 400 stores the bets placed by those audience members, and employs the indication from the presentation server 300 of which one of those possibilities has been presented to determine which of those audience members (if any) have won their bets.

The participation server 400, enables accrual of points by audience members through the automated provision of opportunities to engage in various online activities, including and not limited to, viewing video data (e.g., “blooper” videos, interviews, etc.), participating in online discussion forums, or participating in online quizzes and/or other games, in addition to placing bets. Such online activities of those audience members may be individually recorded and maintained by the participation server 400 as part of individual accounts associated with each of those participating audience members. The participation server 400 may signal the transaction server 500 with indications of points accrued by one or more of those participating audience members to enable them to trade some of those accrued points for various memorabilia items related to that program.

It is envisioned that audience interaction with each of the presentation server 300, the participation server 400 and the transaction server 500 may be through any of a variety of types of presentation device. One or more of the presentation devices 700a-c may be relatively simple presentation devices that provide little more in the way of functionality than to present episodes of that program (e.g., a television, radio, etc.) received via radio-frequency over-air, radio-frequency and/or optical cable-based transmission, and/or streaming via the network 999. Alternatively or additionally, one or more of the presentation devices 700a-c may be relatively sophisticated presentation devices that enable a greater degree of two-way interaction (e.g., a computing device with extensive user interface capabilities) through the network 999, including presentation of episodes.

In various embodiments, the presentation server 300 comprises a processor circuit 350, a storage 360 storing a control routine 340 and an episode data 338, and an interface 390 coupling the presentation server 300 to the network 999. The program episode data 338 comprises at least one episode of an audio/visual program. The at least one episode may be stored as one or more audio and/or video recordings, and may be stored digitally (possibly in a lossy or lossless compressed form) and/or in analog form (e.g., on one or more magnetic tapes or film reels). The program episode data 338 may also comprise additional information about dialog and/or events occurring in the at least one episode, including and not limited to, text for use in providing “closed caption” services to deaf audience members, summaries describing the at least one episode for use in a program guide, etc. As will be explained in greater detail, the at least one episode may be stored in a manner that includes multiple possible variations of a portion of a plot or other aspect of the events that occur within that at least one episode (e.g., multiple possible outcomes of an event, such as multiple possible endings to the at least one episode, etc.). As will also be explained in greater detail, the program episode data 338 may include an indication of which one of these multiple possibilities is selected to be presented at a time when that at least one episode is transmitted by the presentation server 300 to presentation devices to be presented.

In executing a sequence of instructions of at least the control routine 340, the processor circuit 350 is caused to operate the interface 390 to exchange signals with one or more of the presentation devices 700a-c as part of cooperating with them to present an episode of an audio/visual program stored as the program episode data 338. Such cooperation comprises transmitting that episode of that program to one or more of the presentation devices 700a-c through the network 999 (e.g., streaming audio and/or video), through a radio-frequency wireless transmission (e.g., over the air and/or satellite broadcast) and/or via electrically/optically conductive cabling. In so doing, the presentation server 300 may cooperate with one or more other servers (not shown) to enable interruptions in the presentation of that episode to accommodate the presentation of advertisements, breaking news stories, etc. Alternatively or additionally, the presentation server 300 may coordinate presentation of the episode with other related events through exchanges of signals (possibly via the network 999) with the participation server 400, as will shortly be explained.

In various embodiments, the participation server 400 comprises a processor circuit 450, a storage 460, and an interface 490 coupling the participation server 400 to the network 999. Stored within the storage 460 are one or more of a control routine 440, game data 433, betting data 434, forum data 437, other program data 438, and account data 439. In executing a sequence of instructions of at least the control routine 440, the processor circuit 450 is caused to cooperate with one or more of the presentation devices 700a-c to automatically present and/or provide access to various online activities related to the audio/visual program of which at least one episode is stored for transmission by the presentation server 300. Such automated activities may include, without limitation, viewing presentations of videos and/or other content related to that program (e.g., outtakes of recordings of scenes, so-called “blooper reels,” biographies and/or interviews of persons related to that program, etc.), participating in online discussion forums with other audience members about aspects of that program, participating in automated online quizzes and/or various online games related to that program, placing bets on aspects of upcoming episodes of that program, etc. Such aspects on which bets may be placed may include, without limitation, outcomes of events occurring in those episodes such as actions that a fictional character in that program may take, identifying a fictional character that may leave the storyline of that program and/or how they may leave, identifying participants in that program that may be removed as a result of the progress of game play in that program, etc.

The account data 439 comprises profile data and/or other data associated with audience members (e.g., identities, demographics, contact information, etc.) who create accounts maintained by the participation server 400 to enable their participation in such online activities. The forum data 437 comprises data representing texts and/or other information provided by audience members participating in a forum maintained by the participation server 400 about that program (e.g., comments by audience members about an episode of that program, audience member questions about that program, answers to audience member questions by other audience members and/or moderators of the forum, etc.). The other program data 438 comprises recordings of interviews of persons associated with that program, biographies of those persons, recordings of outtakes and/or “bloopers” from recording episodes of that program, reactions to events in episodes by commentators (especially where that program comprises a series of sports events, such as a season of baseball, football, etc.), etc. presented by the participation server 400. The game data 433 comprises data employed by the participation server 400 in providing online games related to the audio/visual program, including and not limited to, quiz questions for online quiz games, graphical representations of game environments and/or depicted objects in online adventure games, statistical information about sports participants for online fantasy sports team games, etc. The betting data 434 comprises data concerning aspects of the program on which opportunities are presented by the participation server 400 to place bets (e.g., events occurring in episode and possible outcomes on which bets may be placed), odds of the occurrence of each of the possibilities of that aspect of the program presented for betting, statistics of which possibilities on which bets have been placed (possibly including how many bets have been placed on each possibility), etc.

In being caused to cooperate with one or more of the presentation devices 700a-c, the processor circuit 450 may be caused to operate the interface 490 to exchange signals with one or more of them to cause the automated presentation of messages (audibly and/or visually) informing one or more audience members of times/dates of presentations of upcoming episodes, opportunities to participate in one or more online activities (e.g., informing audience members of the release of new recordings of “bloopers,” new opportunities to bet on one or more aspects of that program, etc.), the start of a new discussion subject in an online forum related to that program, etc. The participation server 400 may signal one or more of the presentation devices 700a-c to present such messages in “pop-up” windows, as a “ticker” or “crawler” positioned along an edge of a display, etc. Depending on the nature of the message and/or the user interface capabilities of one or more of the presentation devices 700a-c, the participation server 400 may further cooperate with them to enable participating audience members to provide their input back to the participation server 400 (e.g., entry of their comments into a new forum discussion, receipt of indications of bets placed, etc.).

In addition to being caused by execution of the control routine 440 to provide access to and/or automated opportunities to participate in such online activities related to that program, the processor circuit 450 is caused to monitor the participation of each participating audience member and to record the degree to which each has participated as part of their account information in the account data 439. In some embodiments, the processor circuit 450 is caused to award points for participation in such online activities. For example, participating audience members may be given various selected quantities of points for viewing outtakes and/or biographical recordings presented by the participation server 400, answering questions of other audience members in a forum maintained by the participation server 400, correctly answering quiz questions in online games provided by the participation server 400, and/or winning a bet placed with the participation server 400. Thus, through such participation, audience members accrue points, and their point totals are stored by the processor circuit 450 for each such audience member as part of the account data 439.

The processor circuit 450 may further be caused to provide and/or automatically present opportunities for such participating audience members to use their accrued points in various ways that are also related to that program. By way of example, the processor circuit 450 may operate the interface 490 to exchange signals with the presentation server 300 to cooperate with the presentation server 300 in determining which participating audience members (if any) won their bets. As previously discussed, the presentation server 300 may signal the participation server 400 that a selected one of multiple possibilities of an aspect of an episode of a program has been transmitted as part of the presentation of that episode such that which one of those possibilities was selected is now publicly disseminated. The processor circuit 450 uses this information received from the presentation server 300 in examining the bets placed by participating audience members to determine which audience members (if any) won their bets. The processor circuit 450 may then further be caused to operate the interface 490 to signal one or more of the presentation devices 700a-c to present betting results to audience members, possibly in individual messages transmitted to those who placed those bets, informing each of them of whether or not they won, the amount of points they won or lost, etc.

In some embodiments, the presentation server 400 may provide audience members with an opportunity to participate in determining an aspect of what should happen in an episode of that program, possibly through an online game asking for audience members to select one of multiple possibilities and/or through monitoring the betting activity of participating audience members in an online opportunity to place bets on which of those possibilities will occur. Where such an online game is presented to audience members, it may simply be that the one of the possibilities that receives the most votes from audience members participating in that game is the possibility that will be selected to occur when that episode is presented. The processor circuit 450 may be caused to operate the interface 490 to signal the presentation server 300 with the results of the votes in that game, thereby directing the presentation circuit 300 to include the one of the possibilities that was selected by those participating audience members in its transmission of that episode. Alternatively or additionally, where bets are placed by participating audience members on what will happen, the processor circuit 450 may be caused to use those bets as an input in signaling the presentation server 300 to direct which one of the possibilities on which bets could be placed is to occur, perhaps in response to a selected threshold of the quantity or proportion of bets placed on a particular one of those possibilities being reached. Stated differently, those bets may be employed in a manner akin to votes in selecting one of the possibilities.

By way of example of providing and/or automatically presenting opportunities for participating audience members to use their accrued points, the processor circuit 450 may operate the interface 490 to exchange signals with the transaction server 500 to cooperate with the transaction server 500 to enable participating audience members to trade some of their accrued points for memorabilia items related to that program. The processor circuit 450 may be caused to convey portions of the account data 439 relevant to such a transaction such as names of such participating audience members, quantities of points that they've accrued (and therefore, are available for trading) and/or their shipping addresses to which memorabilia items are to be sent. The processor circuit 450 may be caused to receive indications of which memorabilia items participating audience members have traded their points to acquire from the transaction server 500, thereby enabling the processor circuit 450 to update the account data 439 to update their current quantities of points, accordingly.

In various embodiments, the transaction server 500 comprises a processor circuit 550, a storage 560 storing a control routine 440 and possibly one or both of an offerings data 538 and a transaction data 539, and an interface 590 coupling the transaction server 500 to the network 999. The offerings data 538 comprises information concerning available memorabilia items (e.g., pictures of items, descriptions of items, quantities of points that must be traded to acquire them, etc.), and the transaction data 539 comprises information concerning transactions in which memorabilia items have been obtained by participating audience members using their accrued points.

In executing a sequence of instructions of at least the control routine 540, the processor circuit 550 is caused to operate the interface 590 to exchange signals with one or more of the presentation devices 700a-c as part of cooperating with them to perform a transaction in which an audience member uses points accrued through interactive activities supported by the participation server 400 to acquire one or more memorabilia items related to an audio/visual program. In so doing, the processor circuit 550 is caused to also operate the interface 590 to exchange signals with the participation server 400 to receive information therefrom specifying the quantity of points accrued by that audience member and/or other information relevant to such a transaction, such as their name and/or address to which the memorabilia item is to be shipped. The processor circuit 550 may also be caused to operate the interface 590 to transmit the quantity of points used by the audience member in the transaction to the participation server 400, thereby enabling the participation server 400 to update account information associated with that audience member to reflect such use of that quantity of points.

In various embodiments, each of the presentation devices 700a-c comprises a processor circuit 750, a storage 760, controls 720, a display 780, and an interface 790 coupling each of the presentation devices 700a-c to the network 999. The storage 760 stores one or more of a control routine 740, an activity ID (identity) data 739, and a video data 738. As previously discussed, each of the presentation devices 700a-c may incorporate different degrees of user interface capability, and may receive the transmissions of episodes from the presentation server 300 via differing technologies.

By way of example, one of the presentation devices 700a-c may be a relatively simple television with some online interactive capability. It may receive the transmission of episodes via a radio-frequency transmission (e.g., an over-the-air broadcast, a satellite broadcast, a broadcast through cable, etc.), but may also possess the ability to be coupled to the network 999 enabling interaction with the participation server 400. It may have a relatively limited user interface in which the controls 720 comprise a handheld remote control affording some limited ability to enter text and/or to select items presented on the display 780. Therefore, it may be capable of receiving and visually presenting on the display 780 information received from the participating server 400 to the effect that opportunities to participate in a new forum discussion topic, place a bet, view a new episode, participate in an online game, etc. related to a particular program have arisen. In such an example form of one of the presentation devices 700a-c, the processor circuit 750 may be caused to provide this more limited user interface, as well as to operate portions of the interface 790 appropriate to receive radio-frequency transmissions of episodes and receive such information of opportunities for online activities. The processor circuit 750 may then be caused to create images combining video frames of the received episodes with “pop-up” notices, “crawlers” or other forms of visual presentation of such information concerning online activities, and to store those images as the video data 738 for subsequent visual presentation on the display 780.

By way of another example, one of the presentation devices 700a-c may be a more general purpose computing device with a greater range of user interface capabilities. It may receive the transmission of episodes from the presentation server 300 as streamed audio/visual data via the network 999. In such an example form of one of the presentation devices 700a-c, the controls 720 may comprise components enabling text entry, graphical item selection, etc. (e.g., a touchscreen, a combination of mouse and keyboard, a remote keyboard with touchpad, etc.), and the control routine 740 may comprise a web browser and/or another type of user interface routine (e.g., an application for use with particular online services downloaded via the network 999) enabling the processor circuit 750 to provide a more extensive interaction with the participation server 400. The processor circuit 750 may be caused, therefore, to enable an audience member to interact with the participation server 400 more fully to provide profile information about that audience member to enable the participation server 400 to create a individual account, to search for and select outtake recordings to view, to enter text as part of participating in discussions in online forums, to play online games, to trade points for memorabilia items and/or to place bets. The processor circuit 750 may also be caused to receive information from the participation server 400 indicating upcoming opportunities to participate in such online activities and/or indicating upcoming presentations of new episodes. The processor circuit 750 may then be caused to create images combining video frames of received episodes with “pop-up” notices, “crawlers” or other forms of visual presentation of such information, and to store those images as the video data 738 for subsequent visual presentation on the display 780.

Regardless of the exact technologies used in receiving episodes transmitted by the presentation server 300 for presentation, and regardless of the extent of user interface capabilities provided, in interactions with at least the participation server 400, the processor circuit 750 of one or more of the presentation devices 700a-c is caused to operate the interface 790 to transmit the activity ID data 739. The activity ID data 739 comprises an indicator of an identity associated with a particular one of the presentation devices 700a-c and/or a particular audience member operating one or more of the presentation devices 700a-c. It may be that the activity ID data 739 of one or more of the presentation devices 700a-c is associated with one or more individual accounts maintained as part of the account data 439 by the participation server 400. By providing the account data 439 to at least the participation server 400, the participation server 400 may able to automatically distinguish one audience member from another and/or one of an audience member's computing devices from another. In embodiments in which the control routine 740 comprises a web browser, the activity ID data 739 may comprise one or more “cookies” provided to one or more of the presentation devices 700a-c by one of the presentation server 300, participation server 400 and the transaction server 500.

In various embodiments, each of the processor circuits 350, 450, 550 and 750 may comprise any of a wide variety of commercially available processors, including without limitation, an AMD® Athlon®, Duron® or Opteron® processor; an ARM® application, embedded or secure processor; an IBM® and/or Motorola® DragonBall® or PowerPC® processor; an IBM and/or Sony® Cell processor; or an Intel® Celeron®, Core (2) Duo®, Core (2) Quad®, Core i3®, Core i5®, Core i7®, Atom®, Itanium®, Pentium®, Xeon® or XScale® processor. Further, one or more of these processor circuits may comprise a multi-core processor (whether the multiple cores coexist on the same or separate dies), and/or a multi-processor architecture of some other variety by which multiple physically separate processors are in some way linked.

In various embodiments, each of the storages 360, 460, 560 and 760 may be based on any of a wide variety of information storage technologies, possibly including volatile technologies requiring the uninterrupted provision of electric power, and possibly including technologies entailing the use of machine-readable storage media that may or may not be removable. Thus, each of these storages may comprise any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although each of these storages is depicted as a single block, one or more of these may comprise multiple storage devices that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM). It should also be noted that each of these storages may be made up of multiple storage components based on identical storage technology, but which may be maintained separately as a result of specialization in use (e.g., some DRAM devices employed as a main storage while other DRAM devices employed as a distinct frame buffer of a graphics controller).

In various embodiments, each of the interfaces 390, 490, 590 and 790 employ any of a wide variety of signaling technologies enabling each of computing devices 300, 400, 500 and 700a-c to be coupled through the network 999 as has been described. Each of these interfaces comprises circuitry providing at least some of the requisite functionality to enable such coupling. However, each of these interfaces may also be at least partially implemented with sequences of instructions executed by corresponding ones of the processor circuits 350, 450, 550 and 750 (e.g., to implement a protocol stack or other features). Where one or more portions of the network 999 employs electrically and/or optically conductive cabling, corresponding ones of the interfaces 390, 490, 590 and 790 may employ signaling and/or protocols conforming to any of a variety of industry standards, including without limitation, RS-232C, RS-422, USB, Ethernet (IEEE-802.3) or IEEE-1394. Alternatively or additionally, where one or more portions of the network 999 entails the use of wireless signal transmission, corresponding ones of the interfaces 390, 490, 590 and 790 may employ signaling and/or protocols conforming to any of a variety of industry standards, including without limitation, IEEE 802.11a, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1xRTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc. It should be noted that although each of the interfaces 390, 490, 590 and 790 are depicted as a single block, one or more of these may comprise multiple interfaces that may be based on differing signaling technologies. This may be the case especially where one or more of these interfaces couples corresponding ones of the computing devices 300, 400, 500 and 700 to more than one network, each employing differing communications technologies.

In various embodiments, the controls 720 may comprise any of a variety of types of manually-operable controls, including without limitation, lever, rocker, pushbutton or other types of switches; rotary, sliding or other types of variable controls; touch sensors, proximity sensors, heat sensors or bioelectric sensors, etc. The controls 720 may comprise manually-operable controls disposed upon a casing of one or more of the computing devices 700a-c, and/or may comprise manually-operable controls disposed on a separate casing of a physically separate component of corresponding ones of these computing devices (e.g., a remote control coupled to other components via infrared signaling). Alternatively or additionally, the controls 720 may comprise any of a variety of non-tactile user input components, including without limitation, a microphone by which sounds may be detected to enable recognition of a verbal command; a camera through which a face or facial expression may be recognized; an accelerometer by which direction, speed, force, acceleration and/or other characteristics of movement may be detected to enable recognition of a gesture; etc.

In various embodiments, each of the displays 780 may be based on any of a variety of display technologies, including without limitation, a liquid crystal display (LCD), including touch-sensitive, color, and thin-film transistor (TFT) LCD; a plasma display; a light emitting diode (LED) display; an organic light emitting diode (OLED) display; a cathode ray tube (CRT) display, etc. Each of these displays may be disposed on a casing of one or more of the computing devices 700, or may be disposed on a separate casing of a physically separate component of corresponding ones of these computing devices (e.g., a flat panel monitor coupled to other components via cabling).

It should be noted that although FIG. 1 depicts a specific example of one possible distribution of functions among three servers (e.g., the presentation server 300, the participation server 400, and the transaction server 500), other embodiments are possible in which the various functions described as performed by each of these three servers may be distributed differently among a greater or lesser number of computing devices. By way of example, embodiments are possible in which the functions of one or both of the presentation server 300 and the transaction server 500 are also performed by the participation server 400. By way of another example, the functions performed by the participation server 400 may be divided such that functions associated with use of accrued points to bet on aspects of episodes of audio/visual programs are performed by an entirely separate computing device from any computing device providing other online interactive functions.

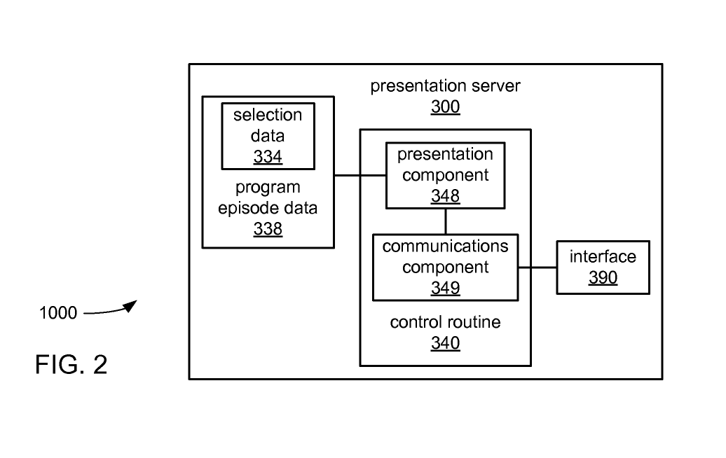

FIGS. 2, 3, 4 and 5, taken together, illustrate block diagrams of portions of the block diagram of FIG. 1 in greater detail. More specifically, aspects of the operating environments of the computing devices 300, 400, 500 and 700a-c are depicted, in which corresponding ones of the processor circuits 350, 450, 550 and 750 (FIG. 1) are caused by execution of respective control routines 340, 440, 540 and 740 to perform the aforedescribed functions. As will be recognized by those skilled in the art, each of the control routines 340, 440, 540 and 740, including the components of which each is composed, are selected to be operative on whatever type of processor or processors that are selected to implement each of the processor circuits 350, 450, 550 and 750.

In various embodiments, one or more of the control routines 340, 440, 540 and 740 may comprise a combination of an operating system, device drivers and/or application-level routines (e.g., so-called “software suites” provided on disc media, “applets” obtained from a remote server, etc.). Where an operating system is included, the operating system may be any of a variety of available operating systems appropriate for whatever corresponding ones of the processor circuits 350, 450, 550 and 750, including without limitation, Windows™, OS X™, Linux®, or Android OS™. Where one or more device drivers are included, those device drivers may provide support for any of a variety of other components, whether hardware or software components, that comprise one or more of the computing devices 300, 400, 500 and 700a-c.

Each of the control routines 340, 440, 540 and 740 comprises a communications component 349, 449, 549 and 749, respectively, executable by corresponding ones of the processor circuits 350, 450, 550 and 750 to operate corresponding ones of the interfaces 390, 490, 590 and 790 to transmit and receive signals via the network 999 as has been described. As will be recognized by those skilled in the art, each of these communications components are selected to be operable with whatever type of interface technology is selected to implement each of the corresponding ones of these interfaces.

Turning more specifically to FIG. 2, the control routine 340 comprises a presentation component 348 executable by the processor circuit 350 to transmit at least one episode of an audio/visual program, stored as the program episode data 338, to one or more of the presentation devices 700a-c for audio and/or visual presentation to one or more members of an audience of that program, as has been previously discussed. As has also been discussed, the at least one episode may be stored as part of the program episode data 338 in any of variety of possible compressed forms, and/or the program episode data 338 may also comprise additional information about dialog and/or events occurring in the at least one episode, including and not limited to, text for use in providing “closed caption” services to deaf audience members, summary text describing the at least one episode for use in a program guide, etc.

As has been discussed, the at least one episode may be stored in a manner that includes multiple possibilities of an aspect of that at least one episode (e.g., multiple possible outcomes of an event within that at least one episode, such as multiple possible plot endings, etc.). As depicted, a selection data 334 comprising an indication of which one of the multiple possibilities of that aspect is selected to be transmitted by the presentation server at a time when that at least one episode is transmitted may be stored as part of the program episode data 338 (alternatively, the selection data 334 may be stored separately from the program episode data 338). As the processor circuit 350 is caused to transmit the at least one episode as a result of executing the presentation component 348, the processor circuit 350 may be further caused to refer to the selection data 334 for an indication of which one of those multiple possibilities to transmit as part of transmitting that at least on episode. More precisely, where the at least one episode is stored in a manner that includes multiple alternative portions (each presenting a different one of the multiple possibilities) of the at least one episode from which one is to be selected to be transmitted as part of transmitting that episode, the processor circuit 350 may be caused to refer to selection data 334 for an indication of which one of those multiple alternative portions is to be transmitted along with the rest of that at least one episode. Also, as the processor circuit 350 is caused to transmit the at least on episode (or possibly at a later time), the processor circuit 350 may be further caused to operate the interface 390 to transmit an indication of which one of the multiple possibilities of that aspect was specified in the selection data 334 and was ultimately transmitted to one or more of the presentation devices 700a-c.

It is envisioned that the presentation server 300 is under the control of personnel involved in creating the at least one episode, and who therefore have a need to know which one of the multiple possibilities is selected for transmission by the presentation server 300. In this way, dissemination of the indication of which one of those multiple possibilities is selected to be transmitted remains relatively limited (e.g., limited to personnel with a need to know and to the presentation server 300) until the time is at hand for the presentation server 300 to actually transmit the at least one episode, thereby aiding in preventing knowledge of that selection from becoming publicly known beforehand.

As has also been discussed, and as an alternative to the presentation server 300 transmitting an indication of which one of multiple possibilities in the at least one episode is selected to the participation server 400, it may be that the participation server 400 transmits to the presentation server 300 which one of the multiple possibilities is selected. As previously discussed, this may occur where an online game and/or opportunity for betting is provided by the participation server 400 in which responses from participating audience members are employed in selecting one of the multiple possibilities. In such embodiments, the processor circuit 350 may be caused to operate the interface 390 to await a signal from the participation server 400 indicating this selection, and may be further caused to store an indication of this selection as the selection data 334 to be referred to by the processor circuit 350 when subsequently caused to operate the interface 390 to transmit the at least one episode, including whatever one of the multiple possibilities of an aspect of the episode is so indicated as in the selection data 334 as having been selected.

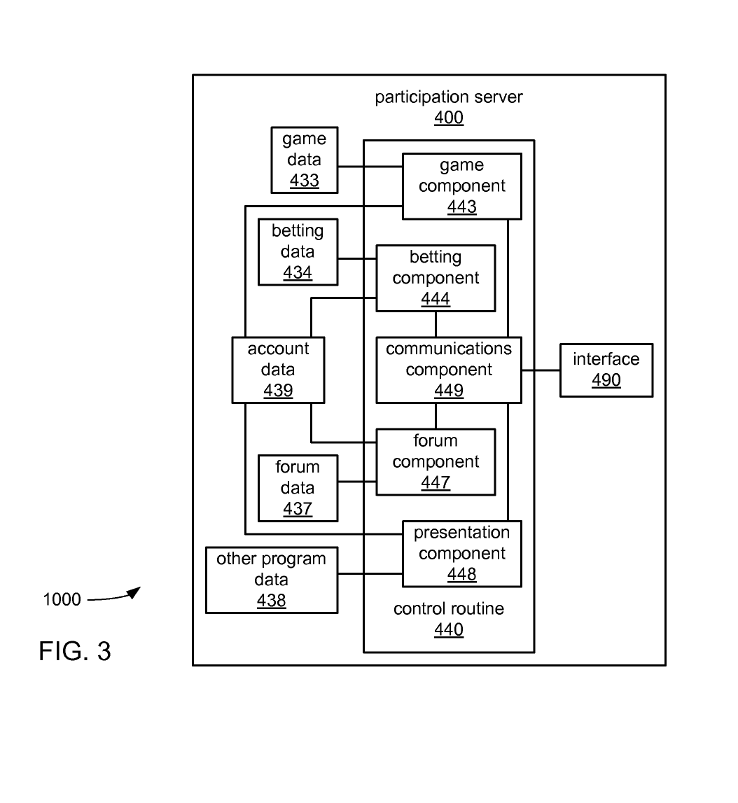

Turning more specifically to FIG. 3, the control routine 440 may comprise a presentation component 448 executable by the processor circuit 450 to receive requests from one or more of the presentation devices 700a-c (operated by participating audience members) via the network 999 to receive audio/visual data other than episodes (e.g., interviews with persons related to an audio/visual program, outtakes of efforts to record episodes, etc.). The processor circuit 450 is further caused to respond to those requests by transmitting such data, stored as the other program data 438, via the network 999 to the ones of the presentation devices 700a-c from which those requests are received.

The control routine 440 may also comprise a forum component 447 executable by the processor circuit 450 to maintain an online forum on which participating audience members may engage in discussions on various topics related to an audio/visual program of which episodes are transmitted by the presentation server 300. The processor circuit 450 is caused to cooperate with one or more of the presentation devices 700a-c to employ their user interfaces to both receive text and/or other content for posting on the forum by each of the participating audience members, and to present that text and/or other content to others of the participating audience members as part of what has been posted. The processor circuit 450 is further caused to store all of that content provided by audience members as the forum data 437, enabling participating audience members to refer to past comments.

The control routine 440 may further comprise a game component 443 executable by the processor circuit 450 to maintain one or more online games that may be played online by participating audience members, the games being related to an audio/visual program of which episodes are transmitted by the presentation server 300. The processor circuit 450 is caused to cooperate with one or more of the presentation devices 700a-c to employ their user interfaces to both receive input from participating audience members and transmit output to be presented to each of the participating audience members as each plays one of the online games. The processor circuit 450 retrieves and uses quiz questions and answers, graphical representations of imaginary game playing environments, graphical representations of objects encountered during game play, etc., and stores those as part of the game data 433 in supporting such online game play.

In making available such online activities, the processor circuit 450 is caused to cooperate with one or more of the presentation devices 700a-c to present participating audience members with requests to provide profile information concerning various aspects of themselves (e.g., name, address, age, gender, etc.) as appropriate to enable the creation of individual accounts for each participating audience member, the processor circuit 450 being caused to maintain such profile information for each as part of the account data 439. The account data 439 also comprises quantities of points earned by each participating audience member having an account as those audience members participate in one or more of these online activities provided by the participating server 400. By way of example, various selected quantities of points may be awarded by the participating server 400 for each audience member viewing various videos stored as part of the other program data 438, or for each audience member correctly answering a quiz question stored as part of the game data 433, or for each audience member who answers a question posed by another audience member on a forum and stored in the forum data 437.

The quantity of points accrued by each participating audience member may be treated as a numerical measure of the degree to which each of those audience members has become an “expert” on a particular audio/visual program, especially where separate point counts are maintained for each program for which an audience member participates in related online activities. The processor circuit 450 may be caused to cooperate with one or more of the presentation devices 700a-c in widely presenting which audience members have the higher point quantities, possibly in a webpage that may be viewed by other audience members, or possibly announced in one of the aforedescribed online forums that the processor circuit 450 is caused to maintain (such announcements possibly made each time a participating audience member achieves one of various selected milestones in a quantity of points they've accrued). Point totals may also be presented each time an audience member answers a question on a forum to encourage the presumption that an answer supplied by an audience member with a higher point quantity than others is to be viewed as more authoritative than others.

As has been discussed, upon accruing an amount of points, an audience member may choose to use some of those points in acquiring memorabilia items offered through the transaction server 500 and/or in placing bets on the participating server 400. Where an audience member chooses to acquire memorabilia items, as previously discussed, the participating server 400 may transmit information concerning that audience member (including profile data) and/or their current quantity of accrued points to the transaction server 500.

In support of an audience member choosing to use some of their accrued points to place a bet (otherwise commonly referred to as a “wager” or a “stake”), the control routine 440 may further comprise a betting component 444 executable by the processor circuit 450 to provide opportunities for such participating audience members to place bets concerning various aspects of an audio/visual program of which episodes are transmitted by the presentation server 300. The processor circuit 450 is caused to cooperate with one or more of the presentation devices 700a-c to employ their user interfaces to both present participating audience members with various possibilities of an aspect of a program (e.g., possible outcomes of an event in an episode of a program) for betting, and receive input from those audience members indicative of bets that they have chosen to place on one of those various possibilities. The processor circuit 450 retrieves and uses indications of what those possibilities are, and stores them as part of the betting data 434 in support of such online betting.

The betting data 434 may also store indications of odds assigned to each of the those possibilities for betting, and those odds may be presented to participating audience members making bets via the user interfaces of one or more of the presentation devices 700a-c. The odds for each possibility on which a bet may be placed may be selected based on any of a variety of mechanisms, including making requests to audience members participating in online quiz games and/or online forums provided by the participating server 400 to supply their input on odds they would assign to each of those possibilities.

As part of the placing of bets, the processor circuit 450 is further caused to receive input from those audience members indicating the quantity of points in each bet. In various embodiments, the placing of a bet by an audience member may result in an update of the account data 439 to deduct the quantity of points used in placing the bet from that audience member's quantity of accrued points in their account, and a corresponding update of the betting data 434 to record the quantity of points used in the placing of that bet by that audience member. Later, if that audience member wins their bet, the account data 439 is then updated to add the quantity of points won in that bet to that audience member's quantity of accrued points (the quantity of points won may be the quantity of points used in placing that bet multiplied by the odds associated with that bet). Alternatively, if that audience member later loses their bet, that audience member's quantity of accrued points in their account (as stored in the account data 439) remains unchanged, since they will have lost the quantity of points that they used in placing that bet. In possible alternative embodiments, that audience member's quantity of accrued points in their account may not actually be updated to reflect either the winning or losing of a bet until the outcome of that bet has been determined Instead, the account data 439 may be updated to mark the quantity of points used by that audience member in placing that bet as having been committed to placing that bet in order to prevent those same accrued points from being used by that audience member for another purpose (e.g., in another bet, in trade for a memorabilia item, etc.).

At a time when the presentation server 300 transmits an episode that includes one of multiple possibilities on which bets have been placed, as previously discussed, the presentation server 300 may signal the participation server 400 with an indication of which one of those multiple possibilities was selected to be transmitted as part of transmitting that episode. The processor circuit 450 is caused, via execution of the betting component 444, to operate the interface 490 to receive this signal, and to then employ the indication of which of the multiple possibilities was selected in determining which audience members (if any) won their bets.

However, as also previously discussed, it may be that the participating server 400 transmits to the presentation server 300 an indication of which one of multiple possibilities is selected in an episode to be transmitted by the presentation server 300 as part of transmitting that episode. In such embodiments, the processor circuit 450 may be caused to select that one of the multiple possibilities via examining the outcome of a contest game in which participating audience members are asked to vote on which of the multiple possibilities should be selected for that episode, with the results possibly not to be known by audience members until that episode is transmitted by the presentation server 300. The processor circuit 450 may alternatively or additionally be caused to analyze the bets made by audience members who have placed bets on which of the various possibilities will be selected, treating each of those bets as a vote for which of the possibilities is preferred by those betting audience members. Thus, the odds for one or more of the various possibilities presented for betting may change over time as more bets are placed, and one or more particular ones of the possibilities become favored over the others by betting audience members.

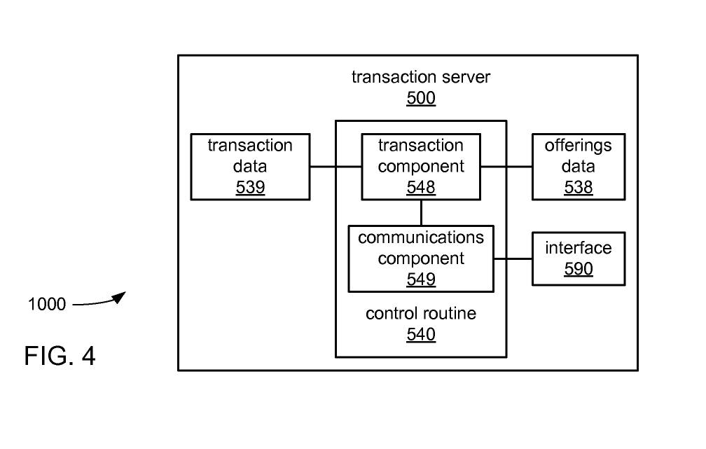

Turning more specifically to FIG. 4, the control routine 540 comprises a transaction component 548 executable by the processor circuit 550 to exchange signals with one or more of the presentation devices 700a-c to cooperate with one or more of them to employ their user interfaces to both receive input from audience members and transmit output to be presented to audience members trading accrued points to acquire memorabilia items offered through the transaction server 500, as has been discussed. As also previously discussed, the transaction server 500 receives information concerning those audience members from the participation server 400 via the network 999, including profile information relevant to such a transaction (e.g., name, address to ship an item to, etc.) and an indication of their accrued quantity of points.

The processor circuit 550 is caused to retrieve information concerning available memorabilia items from the offerings data 538 (e.g., what the items are, descriptions, images, quantities of points required to acquire them, etc.), and to operate the interface 590 to transmit such information to whichever ones of the presentation device 700a-c are operated at any given time to interact with the transaction server 500 as part of carrying out such a transaction. The processor circuit 550 may store information concerning completed transactions in the transactions data 539 and/or may operate the interface 590 to transmit information concerning completed transactions to the participation server 400, including quantities of points traded by each audience member who engages in such a transaction.

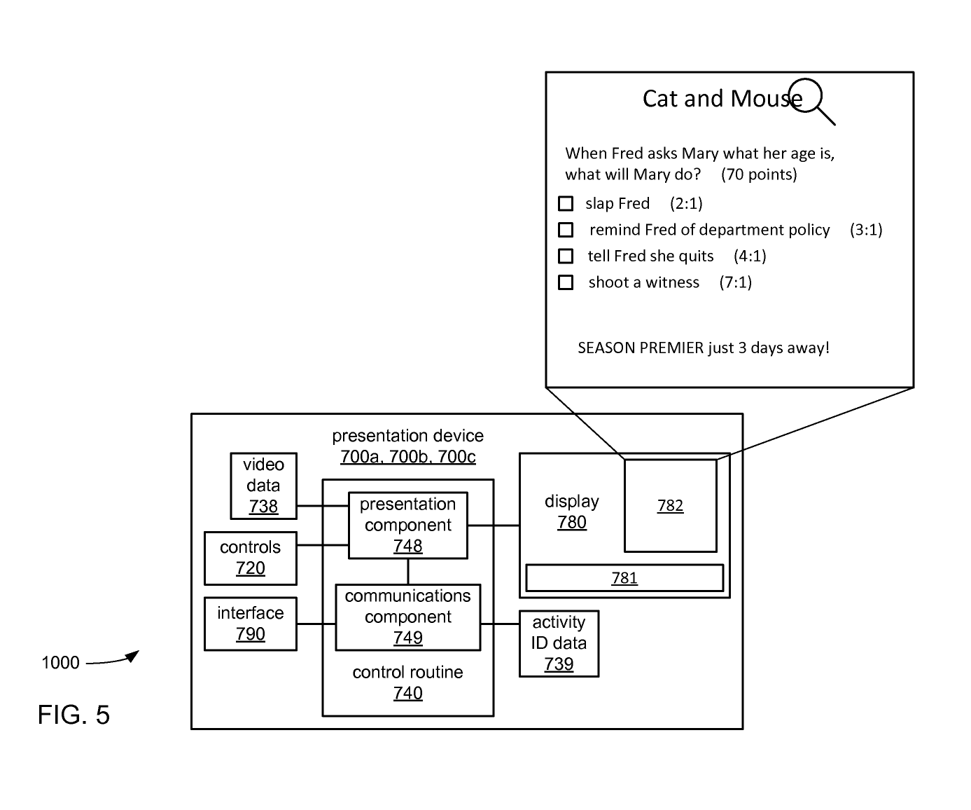

Turning more specifically to FIG. 5, the control routine 740 comprises a presentation component 748 executable by the processor circuit 750 to at least receive an episode transmitted from the presentation server 300, to possibly also receive information from the participating server 400 concerning online activities and/or upcoming episodes, and to visually present a visual portion of the received episode on the display 780 (if there is a visual portion) and/or information received from the participation server 400. Depending on the capabilities of the user interface supported by any particular one of the presentation devices 700a-c, the processor circuit 750 may await receipt of signals indicative of operation of the controls 720 by one or more audience members to adjust settings of that particular presentation device (e.g., volume level, channel selection, mute on/off, etc.) and/or operation to enter text and/or other information to be transmitted to one or more of the presentation server 300 (e.g., to select an episode to receive therefrom), the participation server 400 (e.g., to participate in online activities), or the transaction server 500 (e.g., to select and obtain a memorabilia item).

As previously discussed, the processor circuit 750 may be caused to create images comprising video frames of the received episode and/or imagery visually presenting information received from at least the participation server 400 (and possibly also the transaction server 500), store those images as the video data 738, and then present those images on the display 780. Information concerning online activities received from the participation server 400 may be visually presented in various ways on the display 780 in various portions of the displayable area of the display 780. By way of example, textual information may be displayed as a horizontally scrolling “ticker” or “crawler” 781, possibly along an edge of the display 780 (e.g., along the top or bottom edge). By way of another example, textual and/or graphical information related to online activities supported by the participation server 400 may be presented in a “pop-up” or overlay box 782 at any of a variety of possible locations within the displayable area of the display 780, and may be of any of a variety of shapes and sizes (a substantially square example is depicted in FIG. 5).

In some embodiments, the processor circuit 750 may be caused, by receipt of a signal from the participation server 400 conveying a command, to display such information at a time and/or in a manner directed by the participation server 400. This may be caused to occur where the participation server 400 seeks to cause the presentation of an announcement that a new opportunity to bet on an aspect of a program, inviting an audience member associated with the one of the presentation devices 700a-c on which this announcement is presented to place a bet. Still other information concerning other online activities related to that program may also be triggered by the participation server 400 to be presented on the display 780 by the processor circuit 750. Depicted in FIG. 5 within an expanded view of the “pop-up” box 782 is an example of a opportunity to place a bet offered in which a question is visually presented about an aspect of a program (called “Cat and Mouse” in this depicted example) with four possibilities presented with accompanying odds from which an audience member may choose to place a bet. Also depicted in this example expanded view is an announcement of an upcoming season premiere of the program. An audience member, upon being presented with such an opportunity to place a bet, may operate the controls 720 to use some of their accrued points to place a bet, thereby causing the processor circuit 750 to receive signals indicative of operation of the controls 720 to so place that bet, and causing the processor circuit 750 to operate the interface 790 to signal the participation server 400 with an indication of this bet being placed.

The opportunity to place such a bet may be caused to be presented at a time preceding transmission of the episode associated with the aspect on which bets may be placed, or possibly during transmission of that episode at a point before an event related to that aspect is to occur. At an earlier time, an audience member may be presented with a request received from the participation server 400 for permission to remotely trigger the presentation of information concerning opportunities to participate in online activities. As an alternative to the presentation of opportunities to place bets being triggered by the server 400, it may be that an audience member makes use of a variant of one of the presentation devices 700a-c that incorporates a web browser or similar functionality enabling that audience member to interact with the participation server 400 at a time of their own choosing, and choose from one or more still pending opportunities to place a bet related to a program of interest to them.

Regardless of the manner in which an audience member is caused to place a bet, in some embodiments, the participation server 400 may signal one of the presentation devices to present an audience member who has previously placed a bet with an opportunity to change it (e.g., perhaps to increase the quantity of points they've bet) as a point in an episode approaches where one of multiple possibilities associated with that bet is about to occur. It may be that this opportunity to change a bet is triggered by a change in the odds of at least one of those multiple possibilities.

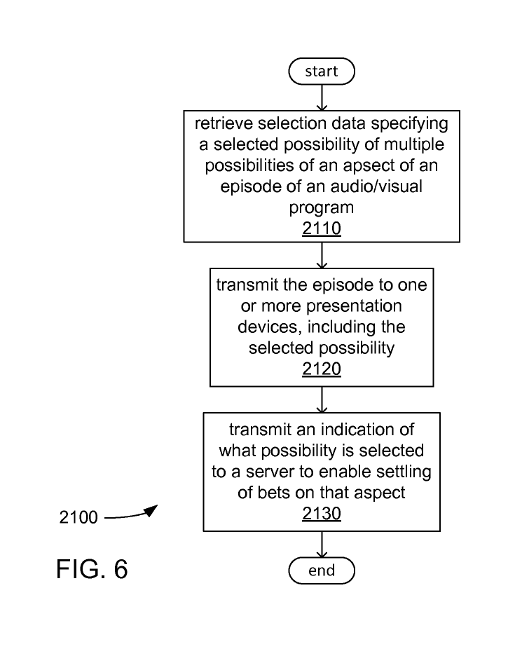

FIG. 6 illustrates an embodiment of a logic flow 2100. The logic flow 2100 may be representative of some or all of the operations executed by one or more embodiments described herein. More specifically, the logic flow 2100 may illustrate operations performed by the processor circuit 350 of one of the presentation server 300 in executing at least the control routine 340.

At 2110, a presentation server (e.g., the presentation server 300) retrieves a selection data (e.g., the selection data 334) specifying a selected possibility of multiple possibilities of an aspect of an episode of an audio/visual program to be transmitted or being transmitted by the presentation server to one or more presentation devices (e.g., the presentation devices 700a-c).

At 2120, the presentation server transmits the episode to the one or more presentation devices, including the selected possibility. As previously discussed, the presentation server may store the episode as multiple portions, one or more of which comprise one or more of the multiple possibilities such that transmitting the selected possibility entails the presentation server selecting one of those portions corresponding to that possibility for transmission.

At 2130, the presentation server transmits an indication of what one of the multiple possibilities is the selected possibility to a server (e.g., the participation server 400) to enable that server to determine which audience members (if any) won their bets as to which of the multiple possibilities would be the selected possibility.

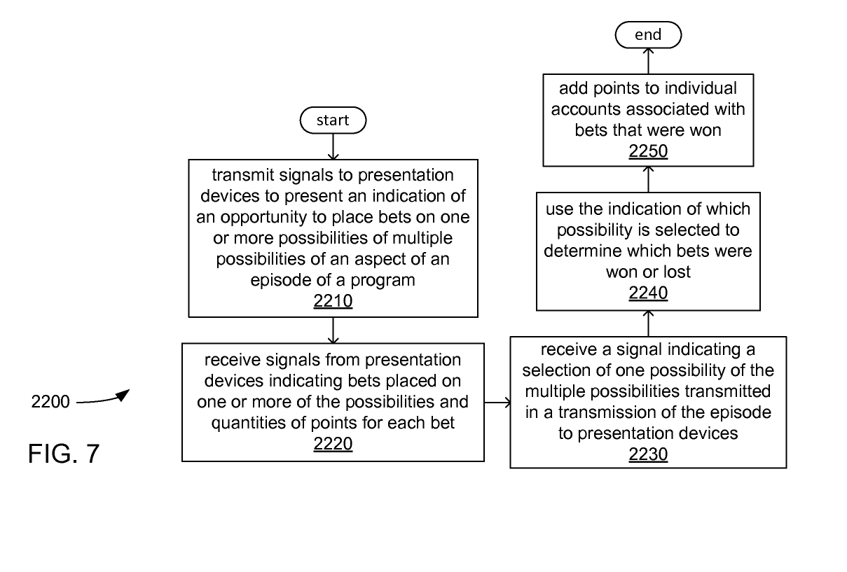

FIG. 7 illustrates an embodiment of a logic flow 2200. The logic flow 2200 may be representative of some or all of the operations executed by one or more embodiments described herein. More specifically, the logic flow 2200 may illustrate operations performed by at least the processor circuit 450 of the participation device 400 in executing at least the control routine 440.

At 2210, a participation server (e.g., the participation server 400) transmits signals to one or more presentation devices (e.g., the presentation devices 700a-c) to present an indication of an opportunity to place bets on one or more possibilities of multiple possibilities of an aspect of an episode of a program (possibly via visual presentations on each of their displays). As previously discussed, in presenting an opportunity to place bets, those presentation devices may be caused to also present odds for each of those possibilities.

At 2220, the participation server receives signals from one or more of those presentation devices indicating bets placed on one or more of the possibilities and quantities of points for each bet.

At 2230, the participation server receives from a presentation server (e.g., the presentation server 300) a signal indicating a selection of one possibility of the multiple possibilities transmitted in a transmission of the episode by the presentation server to one or more presentation devices.

At 2240, the participation server uses the indication of which possibility is selected to determine which bets were won or lost, and updates point quantities of individual accounts associated with participating audience members (if any) who won their bets at 2250.

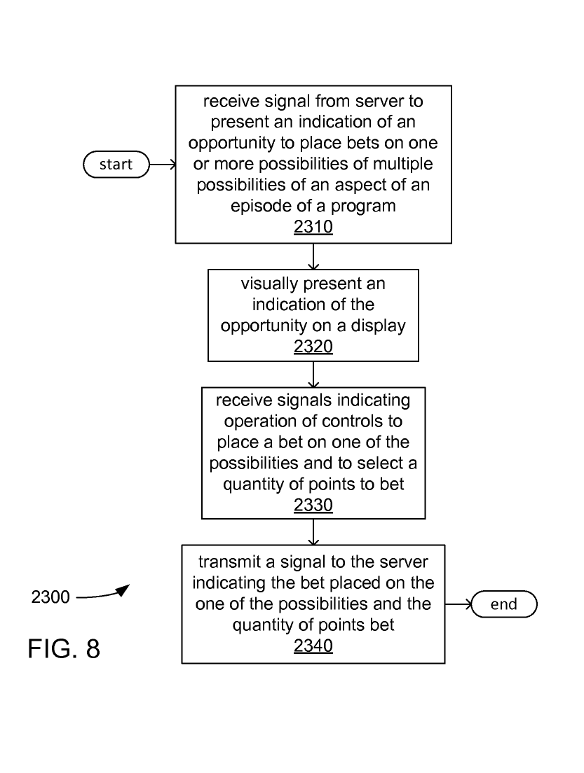

FIG. 8 illustrates an embodiment of a logic flow 2300. The logic flow 2300 may be representative of some or all of the operations executed by one or more embodiments described herein. More specifically, the logic flow 2300 may illustrate operations performed by the processor circuit 750 of one or more of the presentation devices 700a-c in executing at least the control routine 740.

At 2310, a presentation device (e.g., one of the presentation devices 700a-c) receives a signal from a participation server (e.g., the participation server 400) to present an indication of an opportunity to place bets on one or more possibilities of multiple possibilities of an aspect of an episode of a program, and the presentation device visually presents this opportunity on a display of the presentation device (e.g., the display 780) at 2320.

At 2330, the presentation device receives signals indicating operation of controls of the presentation device (e.g., the controls 720) by a participating audience member to place a bet on one of the possibilities and to select a quantity of points to bet.

At 2340, the presentation device signals the participation server with an indication of the bet that was placed, what possibility it was placed on, and the quantity of points that was bet.

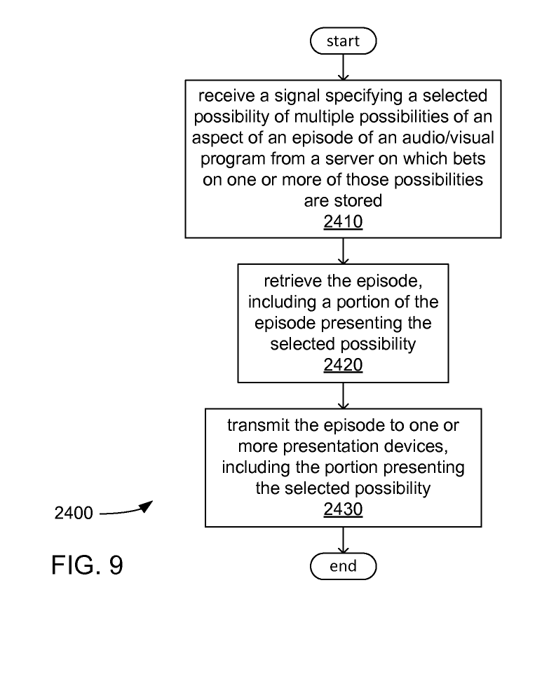

FIG. 9 illustrates an embodiment of a logic flow 2400. The logic flow 2400 may be representative of some or all of the operations executed by one or more embodiments described herein. More specifically, the logic flow 2400 may illustrate operations performed by the processor circuit 350 of one of the presentation server 300 in executing at least the control routine 340.

At 2410, a presentation server (e.g., the presentation server 300) receives a signal specifying a selection of a possibility of multiple possibilities of an aspect of an episode of an audio/visual program from a participation server (e.g., the participation server 400) on which bets on one or more of those possibilities are stored.

At 2420, the presentation server retrieves the episode from its storage, including a portion of the episode in which the selected possibility is presented for transmission.

At 2430, the presentation server transmits the episode to one or more presentation devices (e.g., the presentation devices 700a-c), including the portion presenting the selected possibility.

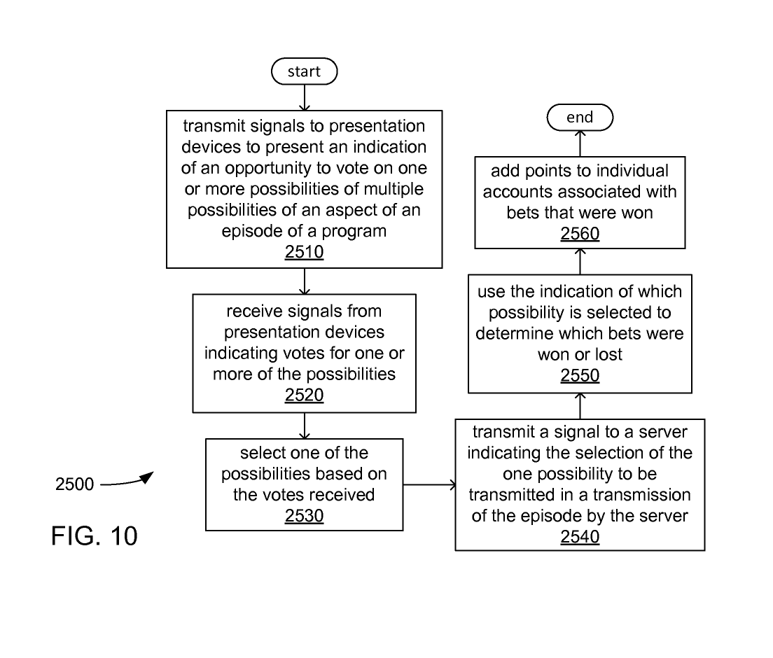

FIG. 10 illustrates an embodiment of a logic flow 2500. The logic flow 2500 may be representative of some or all of the operations executed by one or more embodiments described herein. More specifically, the logic flow 2500 may illustrate operations performed by at least the processor circuit 450 of the participation device 400 in executing at least the control routine 440.

At 2510, a participation server (e.g., the participation server 400) transmits signals to one or more presentation devices (e.g., the presentation devices 700a-c) to present an indication of an opportunity to vote on one or more possibilities of multiple possibilities of an aspect of an episode of a program (possibly via visual presentations on each of their displays).

At 2520, the participation server receives signals from one or more of those presentation devices indicating votes for one or more of the possibilities.

At 2530, the participation server analyzes the votes received and selects one of the possibilities based on those votes.

At 2540, the participation server transmits to a presentation server (e.g., the presentation server 300) a signal indicating which one of the possibilities is the selected possibility to be transmitted in a transmission of the episode by the presentation server to one or more presentation devices.

At 2550, the participation server uses the indication of which possibility is selected to determine which bets made by participating audience members as to which one of the possibilities would occur in the episode (i.e., which of the possibilities would be selected) were won or lost, and updates point quantities of individual accounts associated with those participating audience members (if any) who won their bets at 2560.

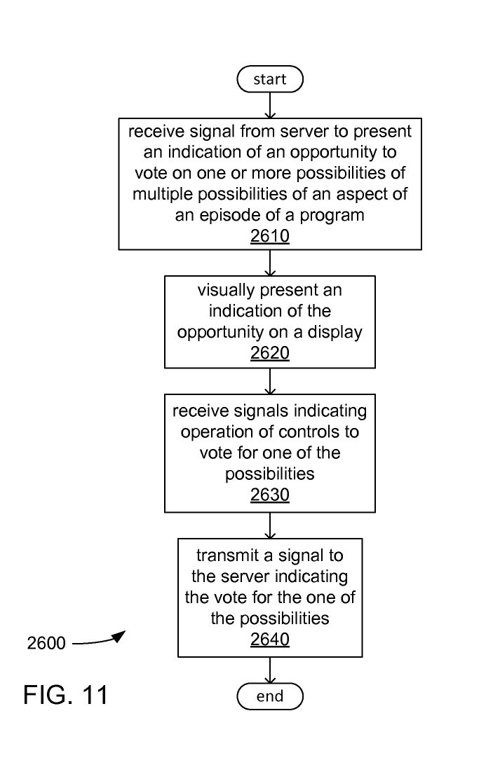

FIG. 11 illustrates an embodiment of a logic flow 2600. The logic flow 2600 may be representative of some or all of the operations executed by one or more embodiments described herein. More specifically, the logic flow 2600 may illustrate operations performed by the processor circuit 750 of one or more of the presentation devices 700a-c in executing at least the control routine 740.

At 2610, a presentation device (e.g., one of the presentation devices 700a-c) receives a signal from a participation server (e.g., the participation server 400) to present an indication of an opportunity to vote for one or more possibilities of multiple possibilities of an aspect of an episode of a program, and the presentation device visually presents this opportunity on a display of the presentation device (e.g., the display 780) at 2620.

At 2630, the presentation device receives signals indicating operation of controls of the presentation device (e.g., the controls 720) by a participating audience member to vote for one of the possibilities.

At 2640, the presentation device signals the participation server with an indication of the vote and for what possibility.

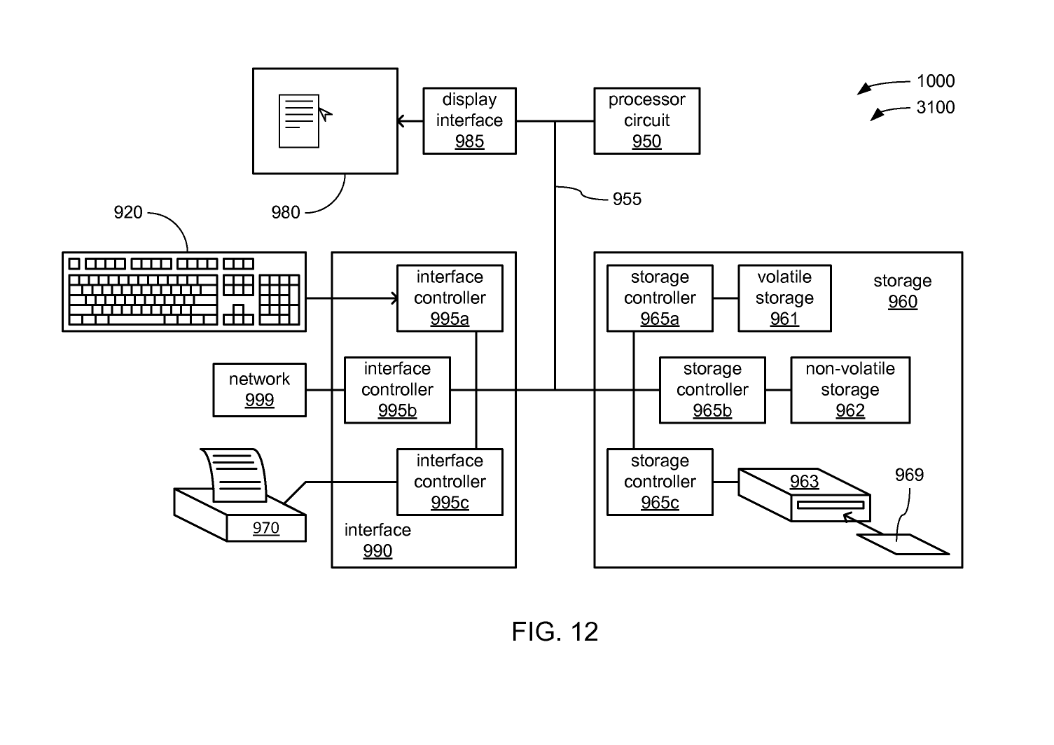

FIG. 12 illustrates an embodiment of an exemplary processing architecture 3100 suitable for implementing various embodiments as previously described. More specifically, the processing architecture 3100 (or variants thereof) may be implemented as part of one or more of the computing devices 300, 400, 500 and 700a-c. It should be noted that components of the processing architecture 3100 are given reference numbers in which the last two digits correspond to the last two digits of reference numbers of components earlier depicted and described as part of each of the computing devices 300, 400, 500 and 700a-c. This is done as an aid to correlating such components of whichever ones of the computing devices 300, 400, 500 or 700a-c may employ this exemplary processing architecture in various embodiments.

The processing architecture 3100 includes various elements commonly employed in digital processing, including without limitation, one or more processors, multi-core processors, co-processors, memory units, chipsets, controllers, peripherals, interfaces, oscillators, timing devices, video cards, audio cards, multimedia input/output (I/O) components, power supplies, etc. As used in this application, the terms “system” and “component” are intended to refer to an entity of a computing device in which digital processing is carried out, that entity being hardware, a combination of hardware and software, software, or software in execution, examples of which are provided by this depicted exemplary processing architecture. For example, a component can be, but is not limited to being, a process running on a processor circuit, the processor circuit itself, a storage device (e.g., a hard disk drive, multiple storage drives in an array, etc.) that may employ an optical and/or magnetic storage medium, an software object, an executable sequence of instructions, a thread of execution, a program, and/or an entire computing device (e.g., an entire computer). By way of illustration, both an application running on a server and the server can be a component. One or more components can reside within a process and/or thread of execution, and a component can be localized on one computing device and/or distributed between two or more computing devices. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to one or more signal lines. Each message may be a signal or a plurality of signals transmitted either serially or substantially in parallel.

As depicted, in implementing the processing architecture 3100, a computing device comprises at least a processor circuit 950, a storage 960, an interface 990 to other devices, and coupling 955. As will be explained, depending on various aspects of a computing device implementing the processing architecture 3100, including its intended use and/or conditions of use, such a computing device may further comprise additional components, such as without limitation, a display interface 985.

Coupling 955 is comprised of one or more buses, point-to-point interconnects, transceivers, buffers, crosspoint switches, and/or other conductors and/or logic that communicatively couples at least the processor circuit 950 to the storage 960. Coupling 955 may further couple the processor circuit 950 to one or more of the interface 990 and the display interface 985 (depending on which of these and/or other components are also present). With the processor circuit 950 being so coupled by couplings 955, the processor circuit 950 is able to perform the various ones of the tasks described at length, above, for whichever ones of the computing devices 300, 400, 500 or 700a-c implement the processing architecture 3100. Coupling 955 may be implemented with any of a variety of technologies or combinations of technologies by which signals are optically and/or electrically conveyed. Further, at least portions of couplings 955 may employ timings and/or protocols conforming to any of a wide variety of industry standards, including without limitation, Accelerated Graphics Port (AGP), CardBus, Extended Industry Standard Architecture (E-ISA), Micro Channel Architecture (MCA), NuBus, Peripheral Component Interconnect (Extended) (PCI-X), PCI Express (PCI-E), Personal Computer Memory Card International Association (PCMCIA) bus, HyperTransport™, QuickPath, and the like.

As previously discussed, the processor circuit 950 (corresponding to one or more of the processor circuits 350, 450, 550 or 750) may comprise any of a wide variety of commercially available processors, employing any of a wide variety of technologies and implemented with one or more cores physically combined in any of a number of ways.

As previously discussed, the storage 960 (corresponding to one or more of the storages 360, 460, 560 or 760) may comprise one or more distinct storage devices based on any of a wide variety of technologies or combinations of technologies. More specifically, as depicted, the storage 960 may comprise one or more of a volatile storage 961 (e.g., solid state storage based on one or more forms of RAM technology), a non-volatile storage 962 (e.g., solid state, ferromagnetic or other storage not requiring a constant provision of electric power to preserve their contents), and a removable media storage 963 (e.g., removable disc or solid state memory card storage by which information may be conveyed between computing devices). This depiction of the storage 960 as possibly comprising multiple distinct types of storage is in recognition of the commonplace use of more than one type of storage device in computing devices in which one type provides relatively rapid reading and writing capabilities enabling more rapid manipulation of data by the processor circuit 950 (but possibly using a “volatile” technology constantly requiring electric power) while another type provides relatively high density of non-volatile storage (but likely provides relatively slow reading and writing capabilities).

Given the often different characteristics of different storage devices employing different technologies, it is also commonplace for such different storage devices to be coupled to other portions of a computing device through different storage controllers coupled to their differing storage devices through different interfaces. By way of example, where the volatile storage 961 is present and is based on RAM technology, the volatile storage 961 may be communicatively coupled to coupling 955 through a storage controller 965a providing an appropriate interface to the volatile storage 961 that perhaps employs row and column addressing, and where the storage controller 965a may perform row refreshing and/or other maintenance tasks to aid in preserving information stored within the volatile storage 961. By way of another example, where the non-volatile storage 962 is present and comprises one or more ferromagnetic and/or solid-state disk drives, the non-volatile storage 962 may be communicatively coupled to coupling 955 through a storage controller 965b providing an appropriate interface to the non-volatile storage 962 that perhaps employs addressing of blocks of information and/or of cylinders and sectors. By way of still another example, where the removable media storage 963 is present and comprises one or more optical and/or solid-state disk drives employing one or more pieces of machine-readable storage media 969, the removable media storage 963 may be communicatively coupled to coupling 955 through a storage controller 965c providing an appropriate interface to the removable media storage 963 that perhaps employs addressing of blocks of information, and where the storage controller 965c may coordinate read, erase and write operations in a manner specific to extending the lifespan of the machine-readable storage media 969.

One or the other of the volatile storage 961 or the non-volatile storage 962 may comprise an article of manufacture in the form of a machine-readable storage media on which a routine comprising a sequence of instructions executable by the processor circuit 950 may be stored, depending on the technologies on which each is based. By way of example, where the non-volatile storage 962 comprises ferromagnetic-based disk drives (e.g., so-called “hard drives”), each such disk drive typically employs one or more rotating platters on which a coating of magnetically responsive particles is deposited and magnetically oriented in various patterns to store information, such as a sequence of instructions, in a manner akin to removable storage media such as a floppy diskette. By way of another example, the non-volatile storage 962 may comprise banks of solid-state storage devices to store information, such as sequences of instructions, in a manner akin to a compact flash card. Again, it is commonplace to employ differing types of storage devices in a computing device at different times to store executable routines and/or data. Thus, a routine comprising a sequence of instructions to be executed by the processor circuit 950 may initially be stored on the machine-readable storage media 969, and the removable media storage 963 may be subsequently employed in copying that routine to the non-volatile storage 962 for longer term storage not requiring the continuing presence of the machine-readable storage media 969 and/or the volatile storage 961 to enable more rapid access by the processor circuit 950 as that routine is executed.

As previously discussed, the interface 990 (corresponding to one or more of the interfaces 390, 490, 590 and 790) may employ any of a variety of signaling technologies corresponding to any of a variety of communications technologies that may be employed to communicatively couple a computing device to one or more other devices. Again, one or both of various forms of wired or wireless signaling may be employed to enable the processor circuit 950 to interact with input/output devices (e.g., the depicted example keyboard 920 or printer 970) and/or other computing devices, possibly through a network (e.g., the network 999) or an interconnected set of networks. In recognition of the often greatly different character of multiple types of signaling and/or protocols that must often be supported by any one computing device, the interface 990 is depicted as comprising multiple different interface controllers 995a, 995b and 995c. The interface controller 995a may employ any of a variety of types of wired digital serial interface or radio frequency wireless interface to receive serially transmitted messages from user input devices, such as the depicted keyboard 920 (perhaps corresponding to the controls 720). The interface controller 995b may employ any of a variety of cabling-based or wireless signaling, timings and/or protocols to access other computing devices through the depicted network 999 (perhaps a network comprising one or more links, smaller networks, or perhaps the Internet). The interface 995c may employ any of a variety of electrically conductive cabling enabling the use of either serial or parallel signal transmission to convey data to the depicted printer 970. Other examples of devices that may be communicatively coupled through one or more interface controllers of the interface 990 include, without limitation, microphones, remote controls, stylus pens, card readers, finger print readers, virtual reality interaction gloves, graphical input tablets, joysticks, other keyboards, retina scanners, the touch input component of touch screens, trackballs, various sensors, laser printers, inkjet printers, mechanical robots, milling machines, etc.

Where a computing device is communicatively coupled to (or perhaps, actually comprises) a display (e.g., the depicted example display 980, corresponding to the display 780), such a computing device implementing the processing architecture 3100 may also comprise the display interface 985. Although more generalized types of interface may be employed in communicatively coupling to a display, the somewhat specialized additional processing often required in visually displaying various forms of content on a display, as well as the somewhat specialized nature of the cabling-based interfaces used, often makes the provision of a distinct display interface desirable. Wired and/or wireless signaling technologies that may be employed by the display interface 985 in a communicative coupling of the display 980 may make use of signaling and/or protocols that conform to any of a variety of industry standards, including without limitation, any of a variety of analog video interfaces, Digital Video Interface (DVI), DisplayPort, etc.

More generally, the various elements of the devices 300, 400, 500 and 700a-c may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

An example of an apparatus comprises a processor circuit; and a storage communicatively coupled to the processor circuit and arranged to store instructions. The instructions are operative on the processor circuit to receive a signal from a presentation server that indicates a selected possibility of multiple possibilities of an aspect of an episode of an audio/visual program; determine whether a bet placed on one possibility of the multiple possibilities was placed on the selected possibility; and update an individual account associated with the bet to add a quantity of points won to a quantity of accrued points of the individual account if the one possibility on which the bet was placed matches the selected possibility.

The above example of an apparatus in which the apparatus comprises an interface operative to communicatively couple the processor circuit to a network, the signal received from the presentation server via the network.

Either of the above examples of an apparatus in which the apparatus comprises controls, the signal indicative of operation of the controls.

Any of the above examples of an apparatus in which the instructions are operative on the processor circuit to transmit a signal to at least one presentation device to trigger the at least one presentation device to present an indication of an opportunity to place the bet on the aspect of the episode of the program.

Any of the above examples of an apparatus in which the instructions are operative on the processor circuit to transmit a signal to the at least one presentation device to present odds for each possibility of the multiple possibilities.

Any of the above examples of an apparatus in which the instructions are operative on the processor circuit to receive a signal from the at least one presentation device that indicates placement of the bet on the one possibility and that indicates the quantity of points.

Any of the above examples of an apparatus in which the instructions are operative on the processor circuit to transmit a signal to the at least one presentation device to trigger the at least one presentation device to present an indication that the bet was won.

Any of the above examples of an apparatus in which the instructions are operative on the processor circuit to receive a signal that conveys profile information of a member of an audience of the program, and store the profile information in the storage as associated with the individual account.

Any of the above examples of an apparatus in which the instructions are operative on the processor circuit to add points to the quantity of accrued points based on participation by the member in an online activity provided by the processor circuit.

An example of another apparatus comprises a processor circuit, and a storage communicatively coupled to the processor circuit and arranged to store instructions. The instructions are operative on the processor circuit to transmit a signal to a presentation server that indicates a selected possibility of multiple possibilities of an aspect of an episode of an audio/visual program; determine whether a bet placed on one possibility of the multiple possibilities was placed on the selected possibility; and update an individual account associated with the bet to add a quantity of points won to a quantity of accrued points of the individual account if the one possibility on which the bet was placed matches the selected possibility.

The above example of another apparatus in which the apparatus comprises an interface operative to communicatively couple the processor circuit to a network, the signal transmitted to the presentation server via the network.

Either of the above examples of another apparatus in which the instructions are operative on the processor circuit to transmit a signal to at least one presentation device to trigger the at least one presentation device to present an indication of an opportunity to vote on the aspect of the episode of the program.

Any of the above examples of another apparatus in which the instructions are operative on the processor circuit to receive a signal from the at least one presentation device that indicates a vote for the one possibility.

Any of the above examples of another apparatus in which the instructions are operative on the processor circuit to determine the selected possibility from indications of multiple votes for at least the one possibility received from the at least one presentation device.

Any of the above examples of another apparatus in which the instructions are operative on the processor circuit to transmit a signal to at least one presentation device to trigger the at least one presentation device to present an indication of an opportunity to place the bet on the aspect of the episode of the program.

Any of the above examples of another apparatus in which the instructions are operative on the processor circuit to receive a signal from the at least one presentation device that indicates placement of the bet on the one possibility and that indicates the quantity of points.

Any of the above examples of another apparatus in which the instructions are operative on the processor circuit to transmit a signal to the at least one presentation device to trigger the at least one presentation device to present an indication that the bet was won.

Any of the above examples of another apparatus in which the instructions are operative on the processor circuit to receive a signal that conveys profile information of a member of an audience of the program, and store the profile information in the storage as associated with the individual account.

Any of the above examples of another apparatus in which the instructions are operative on the processor circuit to add points to the quantity of accrued points based on participation by the member in an online activity provided by the processor circuit.

An example of a computer-implemented method comprises receiving a signal via a network that indicates a selected possibility of multiple possibilities of an aspect of an episode of an audio/visual program; determining whether a bet placed on one possibility of the multiple possibilities was placed on the selected possibility; and updating an individual account associated with the bet to add a quantity of points won to a quantity of accrued points of the individual account if the one possibility on which the bet was placed matches the selected possibility.

The above example of a computer-implemented method in which the method comprises transmitting a signal to at least one presentation device to trigger the at least one presentation device to present an indication of an opportunity to place the bet on the aspect of the episode of the program.

Either of the above examples of a computer-implemented method in which the method comprises transmitting a signal via the network to the at least one presentation device to present odds for each possibility of the multiple possibilities.

Any of the above examples of a computer-implemented method in which the method comprises receiving a signal via the network from the at least one presentation device that indicates placement of the bet on the one possibility and that indicates the quantity of points.

Any of the above examples of a computer-implemented method in which the method comprises transmitting a signal via the network to the at least one presentation device to trigger the at least one presentation device to present an indication that the bet was won.

Any of the above examples of a computer-implemented method in which the method comprises transmitting a signal to at least one presentation device to trigger the at least one presentation device to present an indication of an opportunity to vote on the aspect of the episode of the program.

Any of the above examples of a computer-implemented method in which the method comprises receiving a signal from the at least one presentation device that indicates a vote for the one possibility.

Any of the above examples of a computer-implemented method in which the method comprises determining the selected possibility from indications of multiple votes for at least the one possibility received from the at least one presentation device.

Any of the above examples of a computer-implemented method in which the method comprises transmitting a signal via the network to a presentation server that indicates the selected possibility as selected to be transmitted in transmitting the episode.

An example of at least one machine-readable storage medium comprises instructions that when executed by a computing device, cause the computing device to receive via network a signal from a presentation server that indicates a selected possibility of multiple possibilities of an aspect of an episode of an audio/visual program; determine whether a bet placed on one possibility of the multiple possibilities was placed on the selected possibility; and update an individual account associated with the bet to add a quantity of points won to a quantity of accrued points of the individual account if the one possibility on which the bet was placed matches the selected possibility.

The above example of at least one machine-readable medium in which the computing device is caused to transmit a signal to at least one presentation device to trigger the at least one presentation device to present an indication of an opportunity to place the bet on the aspect of the episode of the program.

Either of the above examples of at least one machine-readable storage medium in which the computing device is caused to receive a signal from the at least one presentation device that indicates placement of the bet on the one possibility and that indicates the quantity of points.

Any of the above examples of at least one machine-readable storage medium in which the computing device is caused to transmit a signal to the at least one presentation device to trigger the at least one presentation device to present an indication that the bet was won.

Any of the above examples of at least one machine-readable storage medium in which the computing device is caused to receive a signal that conveys profile information of a member of an audience of the program, and to store the profile information in the storage as associated with the individual account.

Any of the above examples of at least one machine-readable storage medium in which the computing device is caused to add points to the quantity of accrued points based on participation by the member in an online activity provided by the processor circuit.

1. An apparatus comprising:
a processor circuit; and
a storage communicatively coupled to the processor circuit and arranged to store instructions operative on the processor circuit to:
receive a signal from a presentation server that indicates a selected possibility of multiple possibilities of an aspect of an episode of an audio/visual program;
determine whether a bet placed on one possibility of the multiple possibilities was placed on the selected possibility; and
update an individual account associated with the bet to add a quantity of points won to a quantity of accrued points of the individual account if the one possibility on which the bet was placed matches the selected possibility.

2. The apparatus of claim 1, comprising an interface operative to communicatively couple the processor circuit to a network, the signal received from the presentation server via the network.

3. The apparatus of claim 1, comprising controls, the signal indicative of operation of the controls.

4. The apparatus of claim 1, the instructions operative on the processor circuit to transmit a signal to at least one presentation device to trigger the at least one presentation device to present an indication of an opportunity to place the bet on the aspect of the episode of the program.

5. The apparatus of claim 4, the instructions operative on the processor circuit to transmit a signal to the at least one presentation device to present odds for each possibility of the multiple possibilities.

6. The apparatus of claim 4, the instructions operative on the processor circuit to receive a signal from the at least one presentation device that indicates placement of the bet on the one possibility and that indicates the quantity of points.

7. The apparatus of claim 4, the instructions operative on the processor circuit to transmit a signal to the at least one presentation device to trigger the at least one presentation device to present an indication that the bet was won.

8. The apparatus of claim 1, the instructions operative on the processor circuit to receive a signal that conveys profile information of a member of an audience of the program, and store the profile information in the storage as associated with the individual account.

9. The apparatus of claim 8, the instructions operative on the processor circuit to add points to the quantity of accrued points based on participation by the member in an online activity provided by the processor circuit.

10. An apparatus comprising:
a processor circuit; and
a storage communicatively coupled to the processor circuit and arranged to store instructions operative on the processor circuit to:
transmit a signal to a presentation server that indicates a selected possibility of multiple possibilities of an aspect of an episode of an audio/visual program;
determine whether a bet placed on one possibility of the multiple possibilities was placed on the selected possibility; and
update an individual account associated with the bet to add a quantity of points won to a quantity of accrued points of the individual account if the one possibility on which the bet was placed matches the selected possibility.

11. The apparatus of claim 10, comprising an interface operative to communicatively couple the processor circuit to a network, the signal transmitted to the presentation server via the network.

12. The apparatus of claim 10, the instructions operative on the processor circuit to transmit a signal to at least one presentation device to trigger the at least one presentation device to present an indication of an opportunity to vote on the aspect of the episode of the program.

13. The apparatus of claim 12, the instructions operative on the processor circuit to receive a signal from the at least one presentation device that indicates a vote for the one possibility.

14. The apparatus of claim 13, the instructions operative on the processor circuit to determine the selected possibility from indications of multiple votes for at least the one possibility received from the at least one presentation device.

15. The apparatus of claim 10, the instructions operative on the processor circuit to transmit a signal to at least one presentation device to trigger the at least one presentation device to present an indication of an opportunity to place the bet on the aspect of the episode of the program.

16. The apparatus of claim 15, the instructions operative on the processor circuit to receive a signal from the at least one presentation device that indicates placement of the bet on the one possibility and that indicates the quantity of points.

17. The apparatus of claim 15, the instructions operative on the processor circuit to transmit a signal to the at least one presentation device to trigger the at least one presentation device to present an indication that the bet was won.

18. The apparatus of claim 10, the instructions operative on the processor circuit to receive a signal that conveys profile information of a member of an audience of the program, and store the profile information in the storage as associated with the individual account.

19. The apparatus of claim 18, the instructions operative on the processor circuit to add points to the quantity of accrued points based on participation by the member in an online activity provided by the processor circuit.

20. A computer-implemented method comprising:
receiving a signal via a network that indicates a selected possibility of multiple possibilities of an aspect of an episode of an audio/visual program;
determining whether a bet placed on one possibility of the multiple possibilities was placed on the selected possibility; and
updating an individual account associated with the bet to add a quantity of points won to a quantity of accrued points of the individual account if the one possibility on which the bet was placed matches the selected possibility.

21. The computer-implemented method of claim 20, comprising transmitting a signal to at least one presentation device to trigger the at least one presentation device to present an indication of an opportunity to place the bet on the aspect of the episode of the program.

22. The computer-implemented method of claim 21, comprising transmitting a signal via the network to the at least one presentation device to present odds for each possibility of the multiple possibilities.

23. The computer-implemented method of claim 21, comprising receiving a signal via the network from the at least one presentation device that indicates placement of the bet on the one possibility and that indicates the quantity of points.

24. The computer-implemented method of claim 21, comprising transmitting a signal via the network to the at least one presentation device to trigger the at least one presentation device to present an indication that the bet was won.

25. The computer-implemented method of claim 20, comprising transmitting a signal to at least one presentation device to trigger the at least one presentation device to present an indication of an opportunity to vote on the aspect of the episode of the program.

26. The computer-implemented method of claim 25, comprising receiving a signal from the at least one presentation device that indicates a vote for the one possibility.

27. The computer-implemented method of claim 26, comprising determining the selected possibility from indications of multiple votes for at least the one possibility received from the at least one presentation device.

28. The computer-implemented method of claim 20, comprising transmitting a signal via the network to a presentation server that indicates the selected possibility as selected to be transmitted in transmitting the episode.

29. At least one machine-readable storage medium comprising instructions that when executed by a computing device, cause the computing device to:
receive via network a signal from a presentation server that indicates a selected possibility of multiple possibilities of an aspect of an episode of an audio/visual program;
determine whether a bet placed on one possibility of the multiple possibilities was placed on the selected possibility; and
update an individual account associated with the bet to add a quantity of points won to a quantity of accrued points of the individual account if the one possibility on which the bet was placed matches the selected possibility.

30. The at least one machine-readable storage medium of claim 29, the computing device caused to transmit a signal to at least one presentation device to trigger the at least one presentation device to present an indication of an opportunity to place the bet on the aspect of the episode of the program.

31. The at least one machine-readable storage medium of claim 30, the computing device caused to receive a signal from the at least one presentation device that indicates placement of the bet on the one possibility and that indicates the quantity of points.

32. The at least one machine-readable storage medium of claim 30, the computing device caused to transmit a signal to the at least one presentation device to trigger the at least one presentation device to present an indication that the bet was won.

33. The at least one machine-readable storage medium of claim 29, the computing device caused to receive a signal that conveys profile information of a member of an audience of the program, and store the profile information in the storage as associated with the individual account.

34. The at least one machine-readable storage medium of claim 33, the computing device caused to add points to the quantity of accrued points based on participation by the member in an online activity provided by the processor circuit.
